(19) United States
(12) Patent Application Publication
(10) Pub. No.: US 2004/0247015 A1
(43) Pub. Date: Dec. 9, 2004

(54) Beverage and food temperature notification device

(76) Inventors: Scott A. Wojan, Novi, MI (US); Laurie E. Wojan, Novi, MI (US)

Correspondence Address: Thomas E. Bejin, Young & Basile, P.C., Suite 624, 3001 West Big Beaver Road, Troy, MI, 48084, US

(21) Appl. No.: 10/803,282

(22) Filed: Mar. 18, 2004

Related U.S. Application Data
(60) Provisional application No. 60/455,750, filed on Mar. 19, 2003.
(60) Provisional application No. 60/529,673, filed on Dec. 15, 2003.

(51) Int. Cl. G01K 1/16

(52) U.S. Cl. 374/120

(57) ABSTRACT

A beverage and food temperature and notification device automatically signals, through a combination of audible and visible indicators, whether the contents of a baby beverage or food container have attained, during the process of being heated, a temperature within a predetermined range suitable for serving the beverage or food to a baby. The temperature notification device includes a probe having a temperature responsive end for continuously monitoring the temperature of the beverage or food throughout heating process. The probe is disposed for sliding in a support member, whereby the support member rests upon an upper, open end of the beverage or food container, thereby allowing the longitudinal axis of the probe to be maintained substantially coincident with the longitudinal axis of the beverage or food container, and further allowing the temperature responsive end of the probe to be adjusted to various locations in the container.

### RELATED APPLICATIONS

This application is a continuation of U.S. Provisional Application Ser. No. 60/455,750 filed Mar. 19, 2003, and U.S. Provisional Application Ser. No. 60/529,673 filed Dec. 15, 2003.

### FIELD OF THE INVENTION

The present invention relates to a device for monitoring the temperature of a beverage or food, and more particularly, to a device for automatically indicating, through a combination of audible and visible signals, various stages of a process of heating a baby food or beverage.

### BACKGROUND OF THE INVENTION

When feeding babies, it is usually desirable for the temperature of the beverage, such as milk or formula, or food, such as strained vegetables or meats, to be at normal body temperature (98.6° Fahrenheit), but if not at this exact temperature, then within a suitable temperature range, for example 70° Fahrenheit to 99° Fahrenheit. If the served beverage or food temperature is below or above said range, there is a possibility the baby will reject the beverage or food as unpalatable, or even the unsafe possibility of scalding the baby's mouth.

In order to keep baby beverages or foods from spoiling prior to serving, the container and contents thereof are usually kept refrigerated, typically within a temperature range from 34° Fahrenheit to 45° Fahrenheit, which is a range below the aforementioned, suitable temperature range for feeding. Some baby beverages or foods can be stored at room temperature without spoiling, typically within a range from 63° Fahrenheit to 81° Fahrenheit, which is still a range below the aforementioned body temperature (98.6° Fahrenheit) that many babies will prefer. Thus, in many cases, a care giver must heat the baby beverage or food prior to serving in order to meet a baby's feeding preferences.

Since it is not atypical for a baby to cry suddenly and loudly wanting to be fed, a care giver usually wants to heat the baby beverage or food to said suitable temperature range as quickly as possible, not only to satiate the baby but also to end the troublesome crying. Therefore, to ensure a reasonably quick heat-up time, the preferred heating devices and methods will apply heat to the baby beverage or food container in a rapid fashion. Commercially available baby bottle and food jar warmers can heat the beverage or food contents therein from the aforementioned storage temperature range to the suitable serving temperature range generally within four to thirty minutes, depending on the beverage or food storage temperature, the amount of beverage or food to be heated, and other factors specific to the beverage or food container, the warming device and its attendant method. However, regardless of these factors, a heat-up time exceeding ten minutes is generally unacceptable for most care givers, whereas a heat-up time of five minutes or less is generally preferable.

Conventional heating devices use a jacket of liquid water or steam to heat a container and its baby beverage or food contents. In the first case, the container and contents thereof are partially submerged upright in a vessel of warm or hot water. In the second case, the container and contents thereof are placed upright in a steam chamber. In most commercial devices, household electricity is used to power the heat source, which is typically a resistive heating element. Other non-commercial heating methods are known, such as partially submerging the beverage or food container upright in a vessel of hot tap water or upright in a pan of boiling water on a stove, or simply running hot tap water over the container. Other heat transfer mechanisms are known, such as electric blankets, thermo-chemical reaction blankets or the like. Regardless of the device or method used, in order to achieve sufficiently high heat transfer rates to the beverage or food container and thus the preferably low heat-up times, the heating device's water jacket, steam chamber, or other heat transfer mechanism's temperature is kept at a temperature well above the aforementioned suitable baby beverage or food temperature range. Higher water jacket, steam chamber or other heat transfer mechanism temperatures will yield lower beverage or food heat-up times. Conversely, lower water jacket, steam chamber or other heat transfer mechanism temperatures will yield higher beverage or food heat-up times.

Considering the aforementioned heating devices and attendant methods, those providing the lowest heat-up times will also overheat the bottle to unpalatable or unsafe, scalding temperatures if the beverage or food container is left in the warming device too long. For example, in the case of commercial water jacket heaters, the fastest devices maintain the jacket temperature around 135° Fahrenheit via thermostatic control. If the beverage or food container is left in the water jacket long enough, the temperature of the beverage or food will reach 135° Fahrenheit, which is an unsafe, scalding temperature. In the case of commercial steam chamber heaters, whereby steam is generated in a space maintained at atmospheric pressure, the temperature of the beverage or food could reach 212° Fahrenheit, provided a sufficient amount of steam is generated in the chamber and the beverage or food container remains in the chamber long enough. Steam chamber heaters can suffer another disadvantage, which is the beverage or food never reaches the aforementioned, suitable serving temperature range because the care giver places an insufficient amount of water in the heating chamber at the onset of heating, and thus an insufficient amount of steam is generated.

Thus, to achieve a desired beverage or food temperature during the aforementioned heating processes, and even more importantly, to avoid overheating the baby beverage or food, the care giver must check the temperature of the beverage or food frequently and make sure to remove the beverage or food container from the heating device when the beverage or food reaches the aforementioned, suitable temperature range. This necessity of frequent temperature checking is a hassle in and of itself, but also leads to several other inconveniences. One inconvenience is the care giver's freedom to substantially leave the vicinity in which the heating takes place is reduced, since checking of the beverage or food temperature must occur frequently. Another inconvenience is the care giver must be constantly mindful of the heating process, so as not to forget to check the beverage or food temperature frequently. The latter inconvenience can be particularly troubling during nighttime feedings, when the care giver would most like to return to sleep or rest after initiating the heating process, even if for only a matter of minutes, rather than stay alert to frequently check the beverage or food temperature. Still another inconvenience are the age-old methods care givers use for checking the beverage or food temperature, which in the case of beverages, such as milk, is to sense the temperature by expressing a small amount of milk on a wrist, which is messy and arguably inaccurate, and in the case of foods, such as strained peas, is to test the temperature by tasting a spoonful, which can be unappetizing for some care givers and potentially unhealthy if the soiled spoon is shared between care giver and baby.

Thus, with respect to the above-mentioned heating means and methods, there is an unmet need for providing a baby beverage and food temperature notification apparatus for monitoring the temperature of the contents of a baby beverage or food container throughout the heating process, and for automatically and remotely signaling, preferably via a combination of audible and visible signals, when the baby beverage or food has attained a temperature within a predetermined range suitable for feeding, all this in order to eliminate the common practice and current need to frequently check the baby beverage or food temperature by manual and tactile means.

### SUMMARY OF THE INVENTION

In accordance with the present invention, a preferred embodiment of a beverage and food temperature and notification device automatically signals, via a combination of audible and visible indicators, whether or not the contents of a baby beverage or food container have attained, during the process of being heated, a temperature within a predetermined range suitable for serving the beverage or food to a baby. The beverage and food temperature notification device includes a probe having a temperature responsive end, which may be placed in intimate contact with a baby beverage or food stored in a container for the purpose of continuously monitoring the temperature of said beverage or food throughout heating of said beverage or food. The probe is slideably disposed in a support member, whereby said support member rests upon an upper, open end of said beverage or food container, thereby allowing the longitudinal axis of said probe to be maintained substantially coincident with the longitudinal axis of said beverage or food container, and further allowing the temperature responsive end of said probe to be adjusted to various locations in said container and in the beverage or food contents thereof.

Additionally, said probe includes a temperature sensor for providing an electrical signal that is proportional to a sensed temperature. In addition, a case is provided along said probe for housing operational electrical circuitry. The operational electrical circuitry receives said electrical temperature signal from said temperature sensor.

The case also provides a control area, which is interactive with said operational circuitry, and includes a first switch for activating and deactivating the beverage and food temperature notification device as well as for selecting a volume level for a sound speaker that is housed in the case. Furthermore, the control area includes a second switch for selecting the unit of temperature measurement to be utilized and displayed (° C. or ° F.) in a notification area. The notification area, which is provided on the case, is interactive with said operational circuitry, for indicating various conditions, such as (1) whether or not the beverage and food temperature notification device is activated; (2) whether or not the temperature of a beverage or food being sensed is within a predetermined range suitable for serving to a baby; (3) when the temperature of a beverage or food being sensed has reached a specific target value or target range; (4) the actual temperature of a beverage or food when said temperature is within a predetermined range suitable for serving a baby; and (5) the level of battery life remaining. Specifically, said notification area has a visible indicator, preferably of the liquid crystal display (LCD), which is used in combination with an audible indicator, preferably a speaker or speakers of the piezo type, to notify a user, such as a baby's care giver, of the aforementioned conditions.

To initiate operation, the baby's care giver activates the beverage and food temperature notification device via said first switch, causing said operational circuitry to energize the LCD to indicate said activation. The care giver also uses said first switch to select an appropriate speaker volume from one of at least two sound pressure levels, such as “low” or “high”, whereby a low speaker volume is suitably audible over short distances, such as across a bedroom, and a high speaker volume is suitably audible over a larger distance, such as across an entire home. In addition, the care giver uses said second switch to select the unit of temperature measurement to be utilized and displayed on the LCD (° C. or ° F.). For the purpose of describing the invention henceforth, it will be assumed the selected unit of temperature is “° F.”.

To further commence operation, the probe is inserted through an open end of a beverage or food container, which may be a nursing bottle, food jar or the like, such that the probe is maintained in intimate contact with the baby beverage or food thereof, whereby said intimate contact is intended to occur throughout a heating process of the food container and contents thereof, such as by a commercial baby bottle warmer. Whilst said intimate contact and heating process occur simultaneously, the operational circuitry simultaneously compares the temperature signal received from the temperature sensor to a predetermined temperature range, where said predetermined temperature range is defined preferably as 70° Fahrenheit to 99° Fahrenheit. Whenever the temperature of the beverage or food being heated is less than 70° Fahrenheit, said operational circuitry causes the LCD to display the word “COLD” to indicate the temperature of the beverage or food is unsuitably low for serving to a baby. Meanwhile, the speaker is silent. Whenever the temperature of the beverage or food being heated becomes equal to 70° Fahrenheit, said operational circuitry causes the LCD to instead display “70 COOL” and simultaneously causes the speaker to emit a first audible tone for a discrete length of time at the selected volume level, all this to indicate the temperature of the beverage or food has reached a first point marginally suitable for serving to a baby. Whenever the temperature of the beverage or food being heated becomes equal to or is between 71° Fahrenheit and 89° Fahrenheit, said operational circuitry causes the LCD to instead display the actual value of the temperature measured followed by the word “COOL” (for instance, “86 COOL”), to indicate the temperature of the beverage or food is within a range marginally suitable for serving to a baby. Meanwhile, the speaker is silent. Whenever the temperature of the beverage or food being heated becomes equal to 90° Fahrenheit, said operational circuitry causes the LCD to instead display “90 READY” and simultaneously causes the speaker to emit a second audible tone for a discrete length of time at the selected volume level, whereby the nature of the second tone is clearly distinguishable from the first, all this to indicate the temperature of the beverage or food has reached a first point ideal for serving to a baby, as opposed to the first point marginally suitable for serving to a baby (70° Fahrenheit). Whenever the temperature of the beverage or food being heated becomes equal to or is between 91° Fahrenheit and 99° Fahrenheit, said operational circuitry causes the LCD to instead display the actual value of the temperature measured followed by the word “READY” (for instance, “96 READY”), to indicate the temperature of the beverage or food is within a range ideally suited for serving to a baby. Meanwhile, the speaker is silent. Whenever the temperature of the beverage or food being heated is greater than 99° Fahrenheit, said operational circuitry causes the LCD to instead display the word “HOT” and simultaneously causes the speaker to emit a third audible tone that emits continuously (at the selected volume level) until the device is turned off or until the actual value of the temperature measured decreases to a value equal to or less than 99° Fahrenheit, all this to indicate the temperature of the beverage or food is too high for serving to a baby. At any time during operation, the care giver can deactivate all visible and audible indicators by moving the first said switch of the beverage and food temperature notification device back to the “off” position.

Further areas of applicability of the present invention will become readily apparent from the following detailed description, which is to be read in connection with the accompanying drawings. It should be understood that the detailed description and specific examples, while indicating a preferred embodiment of the invention, are intended for purposes of illustration only and are not intended to limit the scope of the invention.

### BRIEF DESCRIPTION OF THE DRAWINGS

The description herein makes reference to the accompanying drawings wherein like reference numerals refer to like parts throughout the several views, and wherein:

FIG. 1 is an elevation view of the beverage and food temperature notification device according to one embodiment of the present invention;

FIG. 2 is a perspective view of the beverage and food temperature notification device according to one embodiment of the present invention;

FIG. 3 is a front elevation view and a side elevation view of the beverage and food temperature notification device according to one embodiment of the present invention;

FIG. 4 is a partial perspective view of the beverage and food temperature notification device according to one embodiment of the present invention showing a probe support member removed from a probe assembly;

FIG. 5 is an elevation view of the beverage and food temperature notification device shown in FIG. 1, but with different indicia shown on the LCD display;

FIG. 6 is an elevation view of a conventional nursing bottle shown filled with a beverage and fully assembled;

FIG. 7 is an elevation view of the beverage and food temperature notification device of FIG. 1, shown situated against the conventional nursing bottle of FIG. 6 having the nipple and collar assembly of the bottle removed;

FIG. 8 is a flow chart describing the use of and the logic performed by the operational circuitry of one embodiment of the present invention;

FIG. 9 is a view similar to FIG. 1 but showing the support member in a different location relative to the probe and case;

FIG. 10 is similar to FIG. 9, but with different indicia shown on the LCD display;

FIG. 11 is a view similar to FIG. 7, showing another embodiment of the present invention where a non-contact temperature sensor is employed in place of a contact-type temperature sensing probe;

FIG. 12 is similar to FIG. 9, but with different indicia shown on the LCD display;

FIG. 13 is similar to FIG. 9, but with different indicia shown on the LCD display;

FIG. 14 is similar to FIG. 9, but with different indicia shown on the LCD display;

FIG. 15 is an elevational view of the beverage and food temperature notification device according to a second preferred embodiment of the present invention;

FIG. 16 is a side elevation view of the beverage and food temperature notification device according to the second preferred embodiment of the present invention;

FIG. 17 is a top plan view of the beverage and food temperature notification device according to the second preferred embodiment of the present invention;

FIG. 18 is an elevation view of the beverage and food temperature notification device according to the second preferred embodiment of the present invention showing a probe support member removed from a probe assembly;

FIG. 19 is a cross-section view taken along line X-X of FIG. 16, showing a diagrammatic illustration of the operational circuitry of the present invention;

FIG. 20 is an elevation view of the second preferred embodiment beverage and food temperature notification device in use, situated against the conventional nursing bottle of FIG. 6 having the nipple and collar assembly of the bottle removed;

FIG. 21 is a flow chart describing the logic performed by the operational circuitry of a the second preferred embodiment of the present invention;

FIG. 22 is a side elevational view showing an alternately configured case of the beverage and food temperature notification device, wherein the case is of a different shape and the control and message areas may be provided on a top face rather than a side face;

FIG. 23 is a top plan view of the embodiment of FIG. 22; and

FIG. 24 is elevational view similar to FIG. 20, showing a non-contact temperature sensor used in place of a contact-type temperature-sensing probe.

### PREFERRED EMBODIMENT

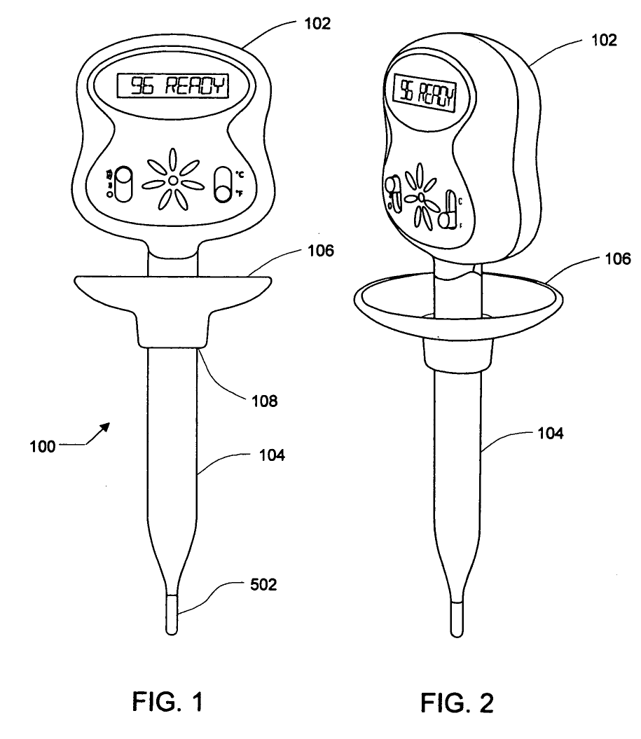

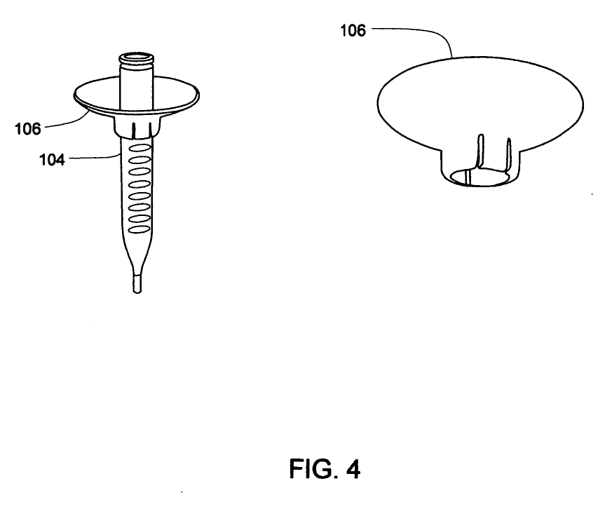

Referring to FIG's 1 and 2 of the drawings, a beverage and food temperature notification device 100, has a case 102 joined to a temperature responsive probe 104, and a support member 106 engaged with said probe. Case 102 houses operational circuitry and a battery or batteries, and includes control and notification areas, which are discussed in greater detail hereinafter. Probe 104 may be constructed at least partially of a suitably heat conductive material, such as stainless steel, may be rigid or flexible in nature, and is preferably rigidly affixed to case 102. Disk-like support member 106 has a centrally located opening 108 that engages probe 104, whereby the support member will normally remain in place relative to the probe. Although said support member is preferably circular, other shapes are possible, such as square, rectangular, triangular and so forth. The static position of support member 106 relative to case 102 and probe 104 may be adjusted by exerting a predetermined amount of force against the support member about the longitudinal axis of probe 104. One possible position of the support member is shown in FIGS. 1 and 2. In addition, as shown in FIG. 4, support member 106 can be removed from probe 104 by sliding action, where said removal will be generally desirable for minimizing the space required for storage of the notification device 100 when not in operation, and for the purposes of compact retail packaging for notification device 100, and for enabling thorough cleaning of probe 104 between uses.

Continuing to refer to FIG. 1, probe 104 houses a temperature sensor (not shown), preferably a thermistor, although other devices, for example, thermocouples or resistance temperature detectors, may be used, where said temperature sensor is typically located at or near tip 502 of said probe for providing an electrical signal that is proportional to a sensed temperature. Probe tip 502 is preferably made from a good conductor of heat, such as stainless steel. Operational circuitry (not shown) is housed in case 102 and receives said electrical temperature signal from said temperature sensor in a generally known manner. Said operational circuitry may comprise analog or digital devices and may be microprocessor based. A replaceable battery or batteries (not shown) powers the operational circuitry. The notification device 100, including case 102, probe 104 and support member 106, may be water resistant or water proof for ensuring reliable operation of said operational circuitry.

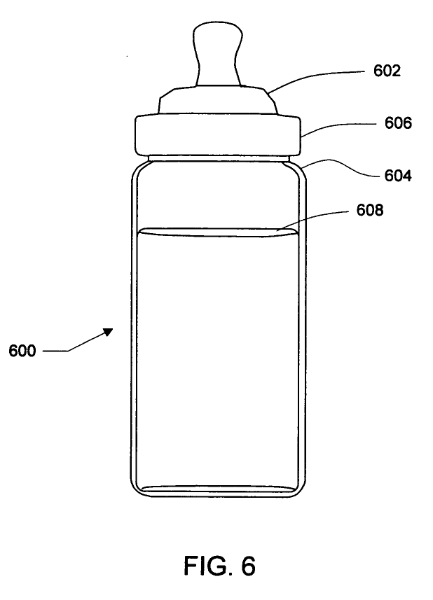

Referring to FIG. 6, there is shown a known nursing bottle 600, having a nipple 602 attached to a bottle 604 by a threaded collar 606. Bottle 604 is shown filled with a beverage or food 608.

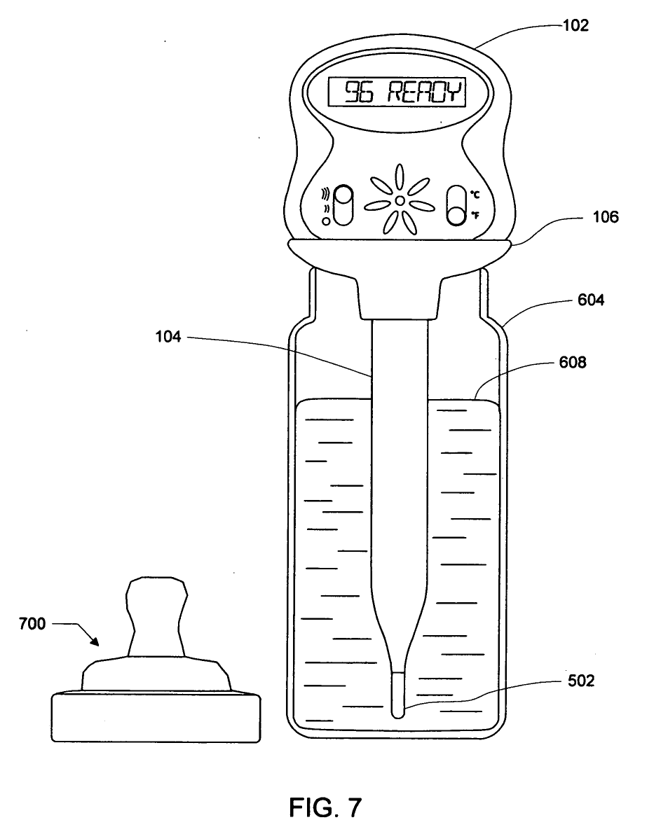

Referring to FIG. 7, notification device 100, is illustrated in use with nursing bottle 600, wherein the nursing bottle and contents thereof are subjected simultaneously to a conventional heating method (not shown), such as upright, partial immersion in water. Specifically, a nipple and collar assembly, designated generally by reference numeral 700, is shown removed from the bottle 604 to provide an opened end of said nursing bottle. Support member 106 rests upon the opened end of the nursing bottle, firstly enabling the notification device 100 to be viewed reliably by a user, such as a baby's care giver, and secondly enabling the notification device 100 to be maintained in operable communication with the nursing bottle and contents thereof. Furthermore, the user can slide case 102 and probe 104 relative to support member 106 in order to position tip 502 of probe 104 at a desired and suitable location within the nursing bottle, specifically into intimate contact with the nursing bottle contents 608, which may be any beverage or food, such as milk, juice, water or cereal, for the purpose of sensing the temperature of said contents. The ability to adjust the position of tip 502 is particularly advantageous given the various shapes and sizes of commercially available baby beverage and food containers, and given the varying amounts of beverage or food that may reside in the container. While support member 106 preferably rests by gravity upon the opened end of the beverage or food container, it should be appreciated that other features for adapting the support member in a more secure or even sealed way to the container can be provided, such as by thread or other clamping feature. In addition, it should be appreciated that the fixed diameter of the support member 106 can be sized so as to fit upon a variety of baby bottles, jars, and the like.

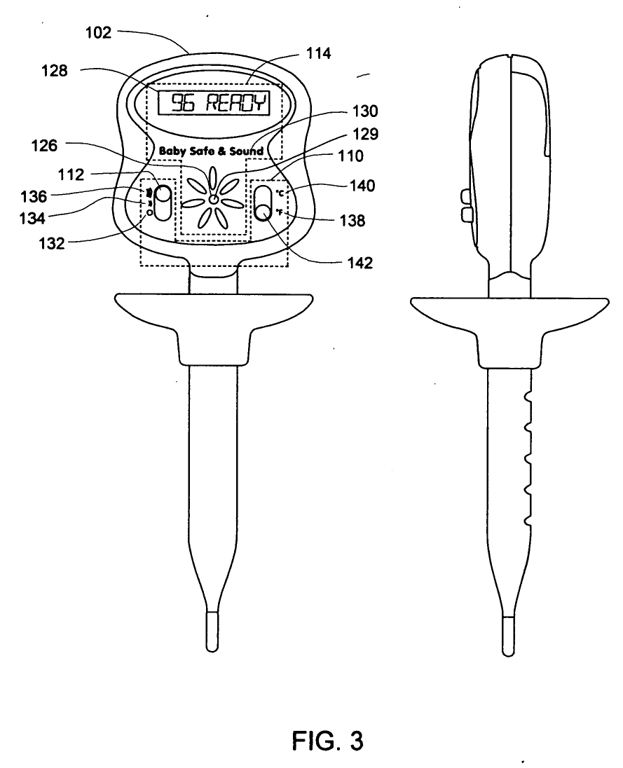

Referring now to FIG. 3, case 102 provides a control area 110, shown in broken line representation, whereby the control area may include a first switch 112 by which the user can activate and deactivate the notification device 100 as well as select a volume level for a sound speaker and a second switch 142 for selecting the unit of temperature measurement to be utilized and displayed (° C. or ° F.) in a notification area 114, which will be discussed later in greater detail. Said control and notification areas are interactive with said operational circuitry, for indicating various conditions, such as (1) whether or not the beverage and food temperature notification device is activated; (2) whether or not the temperature of a beverage or food being sensed is within a predetermined range suitable for serving to a baby; (3) when the temperature of a beverage or food being sensed has reached a specific target value or target range; (4) the actual temperature of a beverage or food when said temperature is within a predetermined range suitable for serving a baby; and (5) the level of battery life remaining. Specifically, said notification area 114, provided by case 102 and shown in broken line representation, comprises a visible indicator 128, preferably of the liquid crystal display (LCD) type, and an audible indicator 129, preferably a speaker or speakers of the piezo type, which may be used in combination to notify a user, such as a baby's care giver, of the aforementioned conditions. Specifically, the LCD displays various indicia to clearly indicate or signal each of the aforementioned conditions. Similarly, the audible indicator 129 signals some of the aforementioned conditions by emitting sound waves that exit through an opening 126 in the face of case 102. In addition to providing a control area 110 and a notification area 114, case 102 provides a surface 130 on which a trademark for the device can be printed. In addition, case 102 provides a surface on which various icons can be printed for clarifying the functional positions of switch 112, such as icons to indicate the “off” position 132, the “low-volume audible signal” position 134, and the “high-volume audible signal” position 136. Similarly, the functional positions of switch 142 are clarified by printed icons that indicate the “° F.” position 138 and the “° C.” position 140.

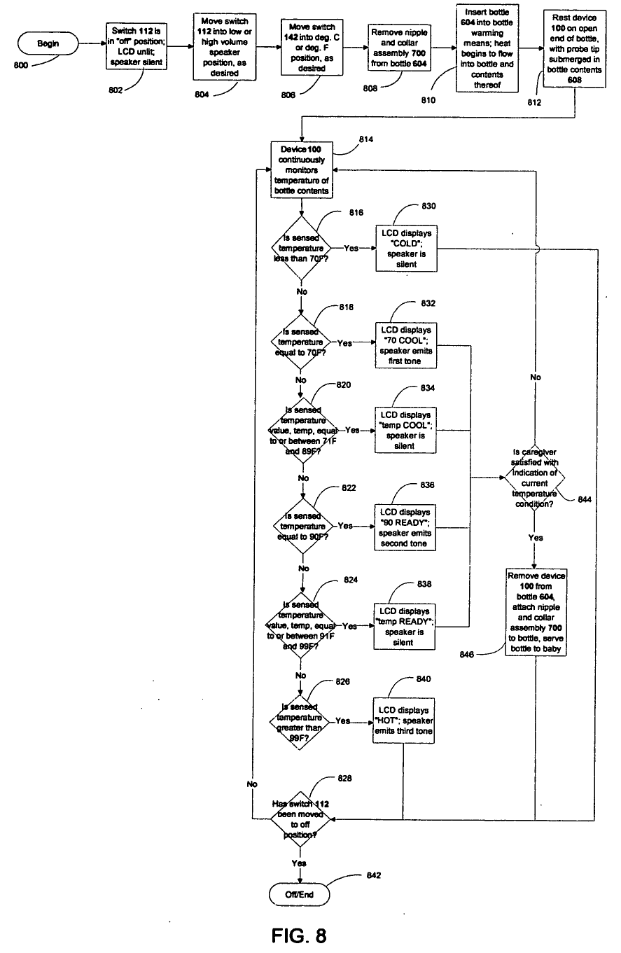

The operation and use of notification device 100, specifically in conjunction with the heating of a baby beverage or food container, such as a nursing bottle, will be better appreciated with specific reference to FIG's 1 and 3 and the logic flow chart shown in FIG. 8. A user's control of notification device 100 starts at step 800. When notification device 100 is in an inoperative state, all visible and audible indicators are de-energized, as shown in step 802. According to step 804, the user can activate the notification device 100 by moving the position of switch 112 from the “off” position 132 into the “low-volume speaker” position 134 or into the “high-volume speaker” position 136, with the latter case illustrated in FIG. 1 and FIG. 3. In a quiet setting, such as a middle-of-the-night baby feeding session in the user's bedroom, the user might select the “low-volume speaker” position 134 so the audible signal, when it occurs, will not awaken members of the household sleeping in other rooms, nor awaken the care giver in a startling manner, should the care giver have intentionally gone back to sleep after completing step 812. Step 812 will be discussed later in further detail. In a louder setting, such as a middle-of-the-day baby feeding session in a home or in a restaurant, the user might select the “high-volume speaker” position 136 to ensure the audible signal, when it occurs, can be heard easily over background noises and over large distances, such as throughout an entire home.

After having selected an appropriate speaker volume level (low or high), the user can select the desired unit of temperature to be used and displayed on the LCD 128, according to step 806. Specifically, the measured temperature value may be displayed in units of degrees Centigrade (° C.) or degrees Fahrenheit (° F.) by moving the position of switch 142 to either position 140 or 138, respectively.

Further use of the notification device 100, with respect to warming of a nursing bottle and contents thereof, occurs according to step 808, whereby a care giver removes the nipple and collar assembly 700, shown in FIG. 7, from a bottle 604 containing a chilled or room-temperature baby beverage 608, such as milk or formula. At step 810, the user inserts the now open bottle upright into a warming means (not shown), preferably but not limited to an electric bottle warmer (water jacket or steam jacket type as previously described), a vessel of hot tap water or water being heated in a pan on a stove, or another known heating method. With the bottle now placed upright in the warming means, heat will begin to flow into the bottle and contents thereof, and the temperature of both will begin to rise.

Immediately after having completed step 810, operation continues according to step 812, whereby the user rests notification device 100 on top of the open bottle as shown in FIG. 7, such that support member 106 is centered in the bottle opening and the longitudinal axis of probe 104 is coincident with the longitudinal axis of the bottle 604, in the case of a straight bottle. The static position of the temperature-sensitive probe tip 502, relative to the contents of the bottle, may be adjusted by sliding the case 102 and probe 104 relative to the support member 106 as previously described. While, for illustrative purposes, probe tip 502 is shown near the bottom of the fluid column 608 residing in the bottle 604, it will normally be more advantageous for the user to position the probe tip at the center of the fluid column, because while the temperature of the fluid may vary by as much as 15° Fahrenheit from top to bottom of the column throughout the warming process, the average temperature will occur somewhere near the longitudinal center of the fluid column. Placement of probe tip 502 at the longitudinal and radial centers of the fluid column will help ensure the overall fluid temperature, when thoroughly mixed, will be acceptably close to the desired temperature.

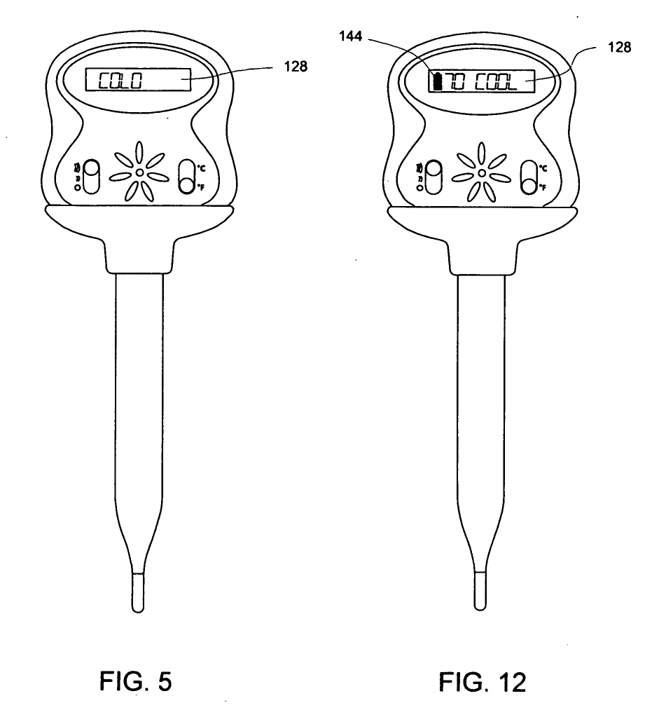

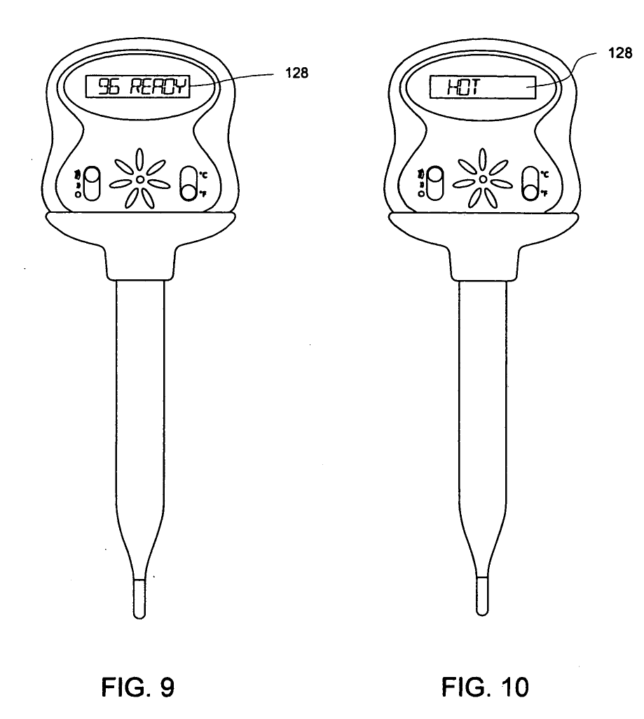

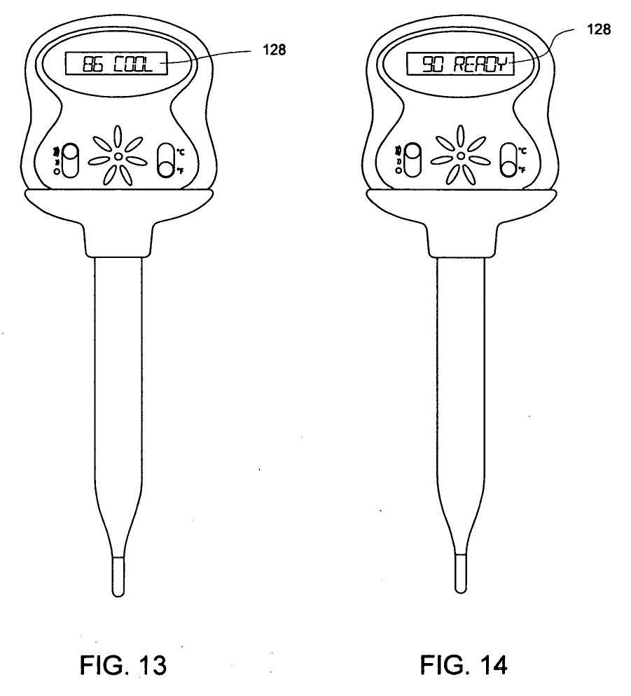

With the notification device 100 now in temperature-sensing communication with the bottle's contents, and with the bottle simultaneously placed in the warming means, operation continues according to step 814. In step 814, the user is advantageously free to leave the vicinity where the bottle is being warmed, or simply not be as mindful of the process, since the previous need for a user to continuously and manually monitor the temperature of the bottle contents is now met automatically by notification device 100. Specifically, in step 814, whilst said temperature sensing and said heating process occur simultaneously, said operational circuitry (not shown) monitors the temperature of the bottle contents via a temperature signal received from said temperature sensor (not shown). As shown in steps 816, 818, 820, 822, 824, 826 and 828, said operational circuitry (not shown) compares the temperature signal received from the temperature sensor (not shown) to a predetermined temperature range, preferably defined as 70°-90° Fahrenheit, and also to individual temperature targets, preferably defined as 70° Fahrenheit and 90° Fahrenheit, although other temperature ranges and targets are possible. Specifically, in step 816, whenever the temperature of the beverage or food being heated is less than 70° Fahrenheit, said operational circuitry causes LCD 128 in step 830 to display the word “COLD” (FIG. 5) to indicate the temperature of the beverage or food is unsuitably low for serving to a baby. Meanwhile, the speaker is silent. Furthermore, according to step 818, whenever the temperature of the beverage or food being heated becomes equal to 70° Fahrenheit, said operational circuitry causes LCD 128 to instead display “70 COOL” (FIG. 12) in step 832 and simultaneously causes the speaker to emit a first audible tone for a discrete length of time at the selected volume level, all this to indicate the temperature of the beverage or food has reached a first point marginally suitable for serving to a baby. Also shown in FIG. 12 is a low battery icon 144, which illuminates on the LCD when the operational circuitry determines the battery life has nearly ended. Furthermore, according to step 820, whenever the temperature of the beverage or food being heated becomes equal to or is between 71° Fahrenheit and 89° Fahrenheit, said operational circuitry causes LCD 128 in step 834 to instead display the actual value of the temperature measured followed by the word “COOL” (for instance, “86 COOL” as shown in FIG. 13), to indicate the temperature of the beverage or food is within a range marginally suitable for serving to a baby. Meanwhile, the speaker is silent. Moreover, according to step 822, whenever the temperature of the beverage or food being heated becomes equal to 90° Fahrenheit, said operational circuitry causes LCD 128 in step 836 to instead display “90 READY”, as shown in FIG. 14, and simultaneously causes the speaker to emit a second audible tone for a discrete length of time at the selected volume level, whereby the nature of the second tone is clearly distinguishable from the first, all this to indicate the temperature of the beverage or food has reached a first point ideal for serving to a baby, as opposed to the first point marginally suitable for serving to a baby (70° Fahrenheit). Still further, according to step 824, whenever the temperature of the beverage or food being heated becomes equal to or is between 91° Fahrenheit and 99° Fahrenheit, said operational circuitry causes the LCD 128 in step 838 to instead display the actual value of the temperature measured followed by the word “READY” (for instance, “96 READY” as shown in FIG. 9), to indicate the temperature of the beverage or food is within a range ideally suited for serving to a baby. Meanwhile, the speaker is silent. Moreover, according to step 826, whenever the temperature of the beverage or food being heated is greater than 99° Fahrenheit, said operational circuitry causes the LCD 128 in step 840 to instead display the word “HOT” (see FIG. 10) and simultaneously causes the speaker to emit a third audible tone at the selected volume level, which emits continuously until the notification device is turned off or until the actual value of the temperature measured decreases to a value equal to or less than 99° Fahrenheit, all this to indicate the temperature of the beverage or food is too high for serving to a baby. Furthermore, according to step 844, whenever the care giver is satisfied with any of the particular temperature conditions indicated in steps 832, 834, 836 or 838, the care giver will proceed to complete the elements of step 846, namely to remove the notification device 100 from the bottle 604, then to attach nipple and collar assembly 700 to the bottle and then to serve the bottle to a baby. Furthermore, according to step 828, at any time during operation the user can deactivate the notification device 100, including all visible and audible indicators, by moving the first switch 112 of the notification device 100 back to the “off” position 132, thus ending the temperature monitoring process at step 842.

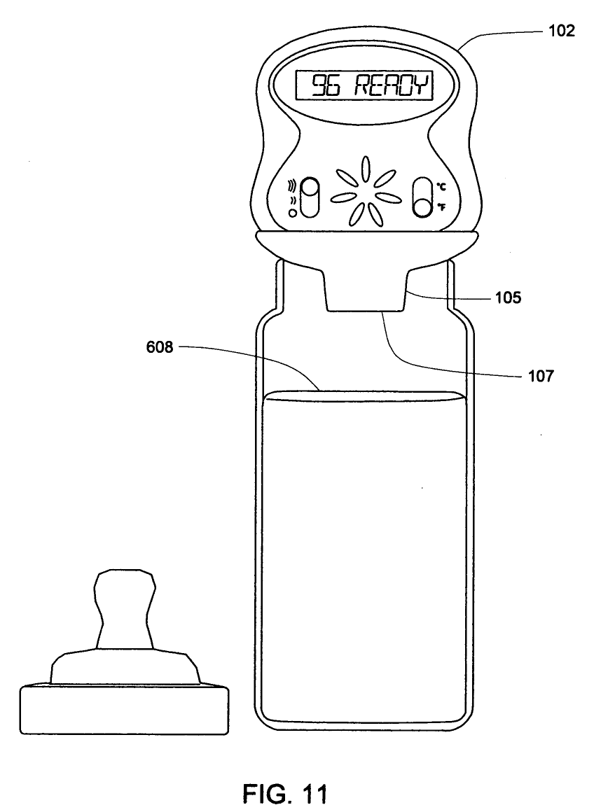

An alternative embodiment of temperature probe is shown in FIG. 11, wherein the contact-type temperature responsive probe 104 is eliminated and substituted with a non-contact temperature sensing means, preferably an infrared temperature sensor 105, whereby the receiving end 107 of the infrared sensor 105 is located above the surface of the column of beverage or food 608. Whereas the surface of the contact-type temperature responsive probe 104 will need to be cleaned between each use in order to prevent food-borne bacteria buildup, no such cleaning will be required by employing a non-contact infrared temperature sensor 105, which provides the obvious advantage of convenience. In addition, the non-contact infrared temperature sensor 105 may be able to ascertain an actual temperature several seconds more quickly than conventional contact-type temperature probes.

Although a first switch 112 is provided for activating and deactivating the notification device 100 as well as for selecting one of two speaker volume levels, and a second switch 142 is provided for selecting desired temperature units to display, it shall be appreciated that other switching and selection techniques may also be provided. For example, a single multifunction switch can be provided to achieve the above functions in concert with icon or menu driven options displayed on the LCD. Similarly, an apparatus can be provided whereby one or more signaled target temperatures within the aforementioned predetermined temperature range can be manually selected by the care giver via an analog or microprocessor-based switching algorithm or protocol, in order to provide the care giver flexibility to target distinct temperatures preferred by a baby. In addition, it may be desirable to incorporate only one level of speaker volume, thereby eliminating a need for a volume selection switch. Furthermore, it shall be appreciated that other combinations of visible and audible signals may be provided, such as providing a visible and audible signal simultaneously to indicate the temperature of a baby beverage or food is too low for serving to a baby, or providing only a visible signal to indicate the temperature of a baby beverage or food is too high for serving to a baby safely. The temperature probe 104 may also be configured to be detachable from the case 102 rather than being permanently affixed to case 102. A detachable probe may be advantageous for purposes of sterilizing the probe without having to subject the case 102 to the same conditions. In addition, the temperature probe 104 and support member 106 may be provided separately from a case 102, whereby the probe 104 transmits a temperature signal wirelessly to a receiver housed in the case 102 using radio frequencies or other known wireless transmission mediums.

Although notification device 100 is preferably adapted to a nursing bottle through an opened end of said nursing bottle, where said opened end is exposed by virtue of having removed the nipple and collar assembly 700 from said nursing bottle 604, other means for adapting notification device 100 to a nursing bottle may be provided. For example, probe 104 of notification device 100 can enter the interior of a nursing bottle through an opening in the nipple or through axially aligned openings in the nipple and collar. Furthermore, the probe can enter the bottle through an opening in a wall of the nursing bottle, where said opening can be provided with a seal for preventing liquid leakage. In addition, notification device 100 can be made as a permanent or removable part of a nursing bottle assembly or any of a nursing bottle's components without deviating from the true spirit and scope of the invention. Furthermore, notification device 100, or similar forms thereof, can be made as a permanent or removable part of a bottle warming means.

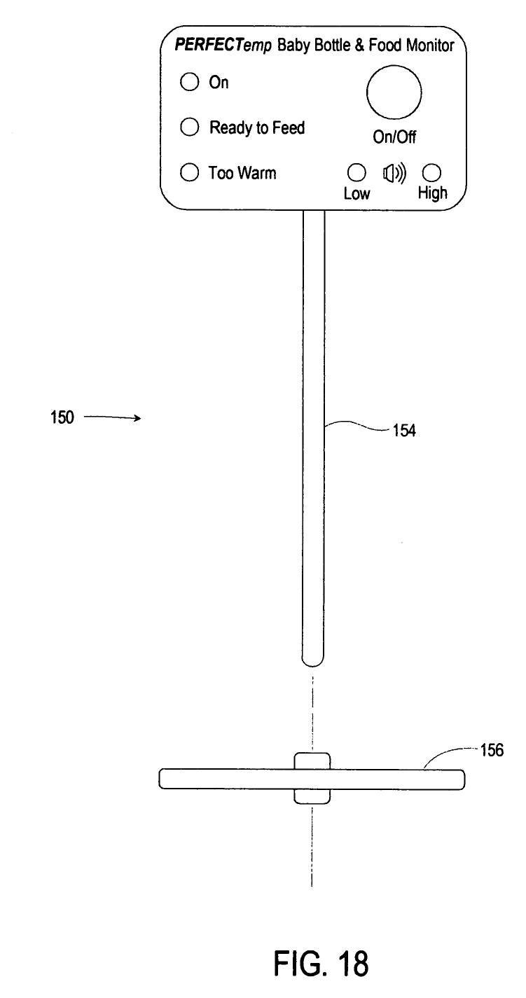

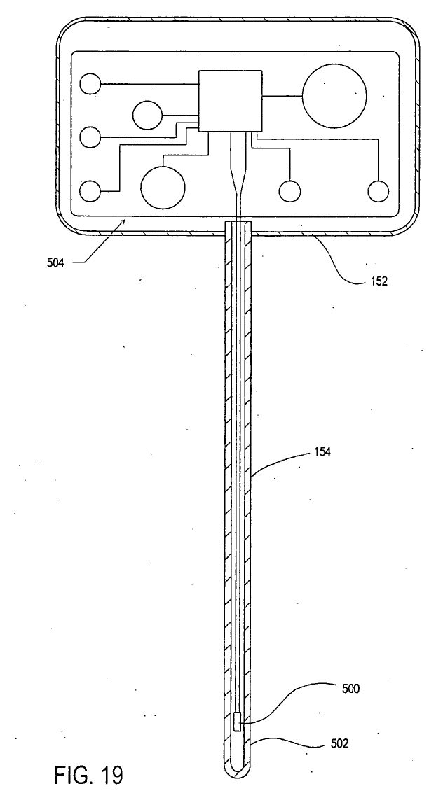

Referring to FIG's 15-19, another embodiment of a beverage and temperature notification device 150 is shown to include a case 152 joined to a temperature responsive probe 154, and a support member 156 engaged with said probe. Case 152 houses operational circuitry 504 and a battery, and includes control and message areas, which are discussed in greater detail hereinafter. Probe 154 may be constructed, at least partially, of a suitably heat conductive material, such as stainless steel. Disk-like support member 156 has a centrally located hole 158 that engages and frictionally slides about probe 154. Although said support member is preferably circular in plan view, other shapes are possible, such as square, rectangular, triangular and so forth. The static position of support member 156 relative to case 152 and probe 154 may be adjusted by sliding the support member about the longitudinal axis of probe 154, wherein one possible position is shown in FIG's 15 and 16. In addition, as shown in FIG. 18, support member 156 can be removed from probe 154 by sliding action, where said removal will be generally desirable for minimizing the space required for storage of the notification device 150 when not in operation.

Probe 154 includes a temperature sensor 500, preferably a thermistor, although other devices, for example, thermocouples or resistance temperature detectors, could be used, where said temperature sensor is typically located at or a near tip 502 of probe 154 for providing an electrical signal that is proportional to a sensed temperature. Operational circuitry 504, is housed in case 152 and receives said electrical temperature signal from temperature sensor 500 in a generally known manner. Operational circuitry 504 may comprise analog or digital devices and may be microprocessor based. A replaceable battery (not shown) powers operational circuitry 504. Case 152 may be water resistant or water proof for ensuring reliable operation of operational circuitry 504.

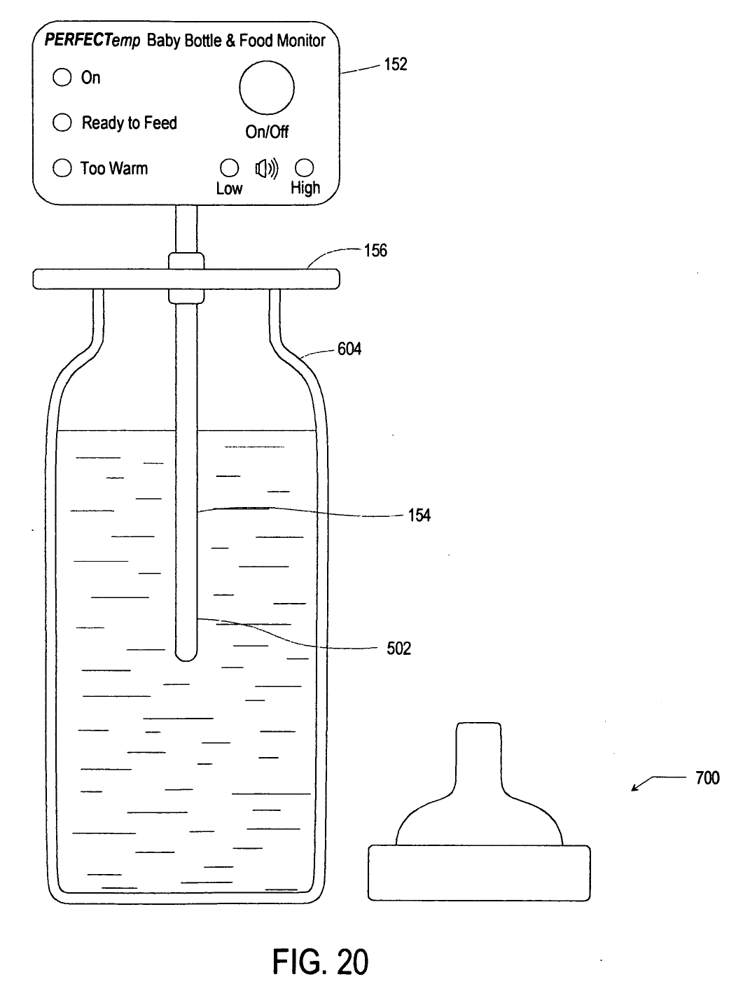

Referring to FIG. 20, notification device 150 is illustrated in use with a conventional nursing bottle 604, wherein the nursing bottle and contents thereof are subjected simultaneously to a conventional heating method (not shown), such as partial immersion in water. Specifically, the nipple and collar assembly 700 is shown removed from bottle 604 to provide an opened end of said nursing bottle. Support member 156 rests upon the opened end of the nursing bottle, firstly enabling monitoring notification device 150 to be viewed reliably by a user, such as a baby's care giver, and secondly enabling notification device 150 to be maintained in operable communication with nursing bottle 604 and contents thereof Furthermore, the user can slide case 152 and probe 154 relative to support member 156 in order to position tip 502 of probe 154 at a desired and suitable location within the nursing bottle, specifically into intimate contact with the nursing bottle contents, which may be any beverage or food (not shown), such as milk, juice, water or cereal, for the purpose of sensing the temperature of said contents. The aforementioned ability to adjust the position of tip 502 is particularly advantageous given the various shapes and sizes of commercially available baby beverage and food containers, and given the varying amounts of beverage or food that may reside in the container. While support member 156 preferably rests by gravity upon the opened end of a beverage or food container, it should be appreciated that other features for adapting the support member in a more secure way to the container can be provided, such as by thread or other clamping feature.

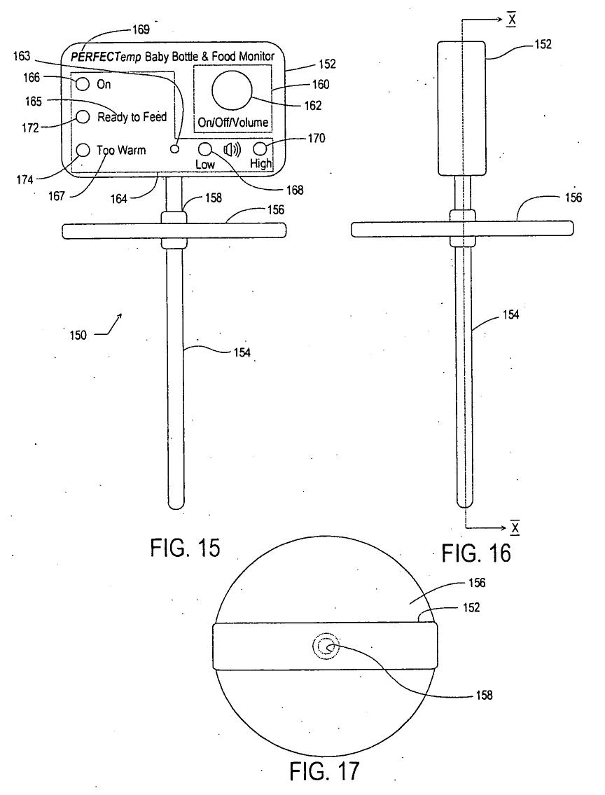

Referring again to FIG. 15, case 152 includes a control area 160, shown in broken line representation, which is interactive with operational circuitry 504. Control-area 160 includes a multifunction push button switch 162 by which the user can activate and deactivate the notification device 150 as well as select a volume level for audible indicator 163, which is housed in case 152. In addition, case 152 includes a notification area 164, shown in broken line representation, which is interactive with operational circuitry 504, for indicating various conditions, such as whether or not notification device 150 is activated, the selected level of speaker volume, and whether or not the temperature of a beverage or food being sensed is within a predetermined range suitable for serving to a baby. Specifically, notification area 164 comprises various visible indicators (to be discussed in greater detail hereinafter) preferably of the light emitting diode (LED) type, which are used in various combinations with audible indicator 163, preferably a speaker or speakers of the piezo type, to notify a user, such as a baby's care giver, of the aforementioned conditions. The aforementioned visible indicators are used in combination with worded and graphics areas 165 and 167 on case 152 for indicating the aforementioned conditions. In addition, case 152 provides a surface 169 on which a trademark for the device can be displayed.

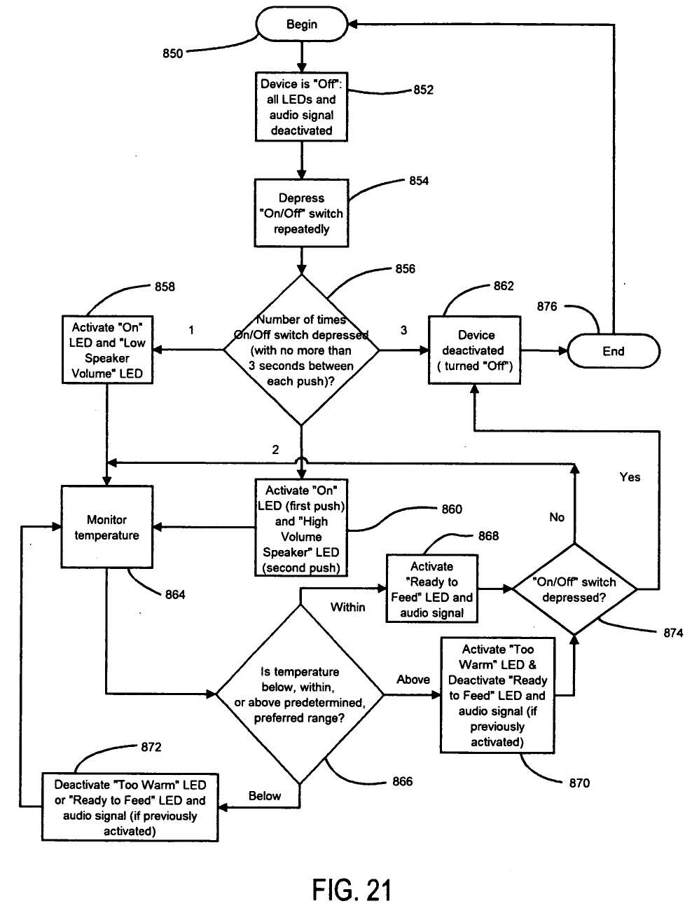

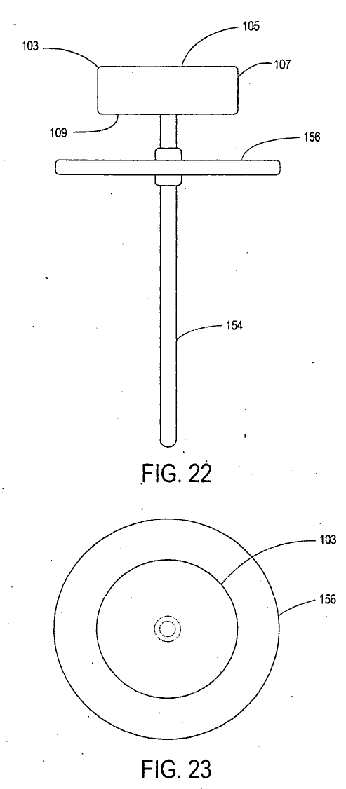

The operation and use of notification device 150, specifically in conjunction with the heating of a baby beverage or food container, such as nursing bottle 604, will be better appreciated with specific reference to FIG's 15 and 20 and the logic flow chart shown in FIG. 21. Control of notification device 150 starts at step 850. When device 150 is in an inoperative state, all visible and audible indicia are deactivated, as shown in step 852. In operation, the user can activate notification device 150 by depressing switch 162. Specifically, the user must depress switch 162 repeatedly, as shown in step 854, in order to activate notification device 150 and select a desired speaker volume from one of at least two sound pressure levels, such as “low” or “high”, whereby a “low” sound pressure volume is suitably audible over short distances, such as across a bedroom, and a “high” sound pressure volume is suitably audible over a larger distance, such as across an entire home. Operational circuitry 504 monitors the amount of time that elapses between each distinct depression of switch 162. After sensing and counting the initial depression, a subsequent depression is counted by the operational circuitry only if it occurs within three seconds of the prior depression, which is a preferred maximum period of time, although other time periods are possible. If and when more than three seconds elapses after any counted switch depression, the logical decision in step 856 is completed. Specifically, as shown in step 856, the number of distinct switch depressions sensed and counted by the operational circuitry determines the operational state of the notification device 150 and the selected volume level. If only one distinct switch depression is counted, the “On” LED 166 and “Low” speaker volume LED 168 are lit by the operational circuitry, as shown in step 858. Alternatively, if two distinct switch depressions are counted, only the “On” LED 166 and “High” speaker volume LED 170 are lit by the operational circuitry, as shown in step 860. Alternatively, if three distinct switch depressions are counted, notification device 150 and all indicia are returned to the aforementioned inoperative state, as shown in step 862.

In operation, probe 154 is inserted through an open end of a beverage or food container, which may be the nursing bottle 604, a food jar or the like, such that probe 154 is maintained in intimate contact with the baby beverage or food, whereby said intimate contact is intended to occur throughout a heating process of the food container and contents thereof, such as by a commercial baby bottle warmer. Whilst said intimate contact and heating process occur simultaneously, operational circuitry 504 simultaneously monitors and compares the temperature signal received from temperature sensor 500 to a predetermined temperature range, as shown in steps 864 and 866 respectively, where said predetermined temperature range is defined preferably as 90° Fahrenheit to 100° Fahrenheit, although other such temperature ranges are possible. As shown in step 868, whenever the temperature of the beverage or food being heated is within the range of 90° Fahrenheit to 100° Fahrenheit, said operational circuitry illuminates “Ready to Feed” LED 172 to indicate the temperature of the beverage or food is suitable for serving to a baby, and operational circuitry 504 simultaneously activates speaker 163 at said selected speaker volume to provide audible and remote notification of the same. The audible signal is preferably cyclic in nature, providing a series of five distinct beep tones followed by 15 seconds of silence, with the duration of each beep tone being one half second and with each beep tone spaced one half second apart, although other audio signals are possible, such as continuous chimes, songs or the like. The “Ready to Feed” LED 172 remains lit and the audio signal repeats as long as the temperature signal is between 90° Fahrenheit and 100° Fahrenheit. However, whenever the temperature of the beverage or food being heated exceeds 100° Fahrenheit, said operational circuitry first deactivates the “Ready to Feed” LED 172 and the audio signal, then lights a “Too Warm” LED 174 to indicate the temperature of the beverage or food is not suitable for serving to a baby, as shown in step 870. As shown in step 872, whenever the temperature of the beverage or food is below 90° Fahrenheit, all visible or audible signals are deactivated other than “On” LED 166 and whichever LED is active for signaling volume level, namely “Low” LED 168 or “High” LED 170. Furthermore, as shown in step 874, the notification device 150 and all aforementioned visible and audible indicators are deactivated if and when the user depresses switch 162 at any time subsequent to notification device 150 having started to monitor temperature in step 864, and control of notification device 150 subsequently ends at step 876.

Referring to FIG's 22 and 23, notification device 150 is shown with an alternately configured case 103. Case 103 is shown as one of a variety of alternative shapes, in this instance a cylindrical shape. It should also be appreciated the aforementioned control area and notification area may be provided on a top 105, side 107 or bottom face 109.

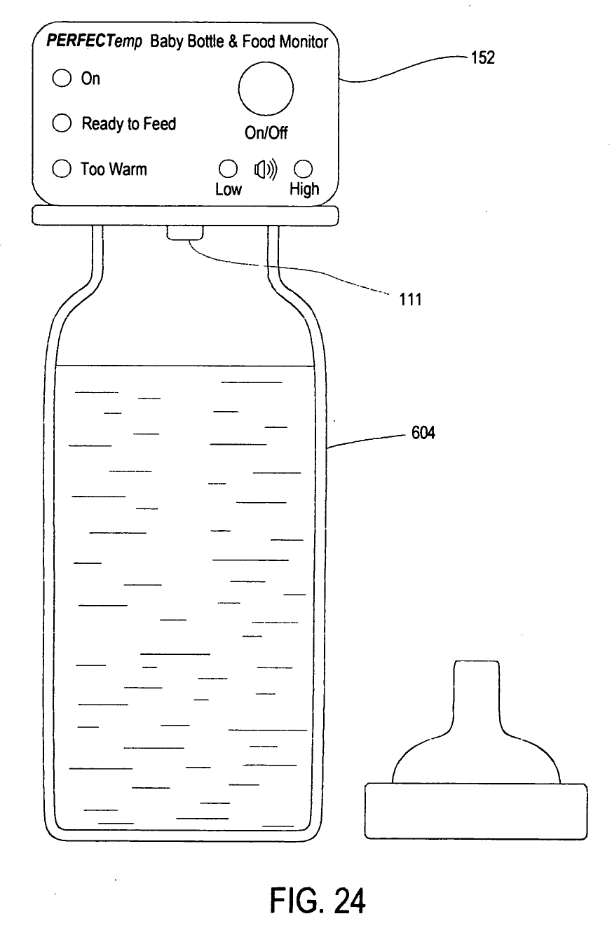

Referring to FIG. 24, the contact-type temperature responsive probe 154 may be replaced with a non-contact temperature sensing means, preferably an infrared temperature sensor 111. While the contact-type temperature responsive probe 154 may need to be cleaned of beverage or food subsequent to use, no such cleaning will be required by employing a non-contact infrared temperature sensor, which can be advantageous. In addition, the non-contact infrared temperature sensor can sense temperature accurately more quickly than typical contact-type temperature probes, which may also be advantageous.

Although multifunction push switch 162 is preferred for activating and deactivating the notification device 150, as well as for selecting one of at least two speaker volume levels, it should be appreciated that other switching techniques may also be provided. For example, a single switch can be provided for activating or deactivating the notification device 150 and a separate switch can be provided for selecting one of at least two volume levels. In addition, it may also be desirable to provide only one level of speaker volume, thereby eliminating a need for a volume selection switch. Furthermore, it shall be appreciated that other combinations of visible and audible signals may also be provided, such as providing a visible and audible signal simultaneously to indicate the temperature of a baby beverage or food is too high for serving safely to a baby, or providing a visible signal to indicate the temperature of a baby beverage or food is too low for serving to a baby.

Although notification device 150 is preferably adapted to a nursing bottle through an opened end of said nursing bottle, where said opened end is exposed by virtue of having removed a nipple and collar assembly from said nursing bottle, other means for adapting notification device 150 to a nursing bottle can be provided without having to remove the nipple and collar from the bottle prior to use of the device. For example, probe 154 of notification device 150 can enter the interior of a nursing bottle through a hole in the nipple or through axially aligned holes in the nipple and collar. Furthermore, probe 154 can enter the bottle through a hole in a wall of the nursing bottle, where said hole can be provided with a seal for preventing liquid leakage. In addition, notification device 150 can be made as a permanent or removable part of a nursing bottle assembly or any of a nursing bottle's components, without deviating from the true spirit and scope of the invention. Furthermore, notification device 150, or similar forms thereof, can be made as a permanent or removable part of a bottle warming means.

What is claimed is:

1. An electronic food and beverage temperature monitor for detecting and monitoring a temperature of a food or beverage contained within a vessel, the temperature monitor comprising:
a housing;
a control device enclosed within the housing; and
a infrared temperature sensor in operable communication with the control device for detecting a temperature of the food or beverage contained in the vessel.

2. The temperature monitor of claim 1, wherein the infrared temperature sensor comprises a viewing end for receiving infrared light emitted from the food or beverage contained in the vessel.

3. The temperature monitor of claim 1 further comprising an audio device for emitting an audible tone, the audio device operably connected to the control device.

4. The temperature monitor of claim 3, wherein the control device is configured to cause the audio device to emit the audible tone when the detected temperature is at a predetermined temperature.

5. The temperature monitor of claim 1 further comprising a display device operably connected to the control device.

6. The temperature monitor of claim 5, wherein the display device comprises at least one light emitting diode.

7. The temperature monitor of claim 5, wherein the display device comprises a liquid crystal display.

8. The temperature monitor of claim 1 further comprising a support member positioned adjacent the infrared temperature sensor and having substantially planar portion extending radially outward from the infrared temperature sensor for supporting the temperature monitor upon a rim of the vessel.

9. The temperature monitor of claim 8, wherein the substantially planar portion of the support member has an upper surface positioned toward the housing and a lower surface positioned away from the housing, the lower surface being engageable with a rim of the vessel so as to position the infrared sensor such that the viewing end of the infrared sensor has an unobstructed view of the food or beverage contained in the vessel.

10. The temperature monitor of claim 8, wherein the support member has an arcuate shape forming a concave upper surface and a convex lower surface.

11. The temperature monitor of claim 10, wherein a principal axis of the support member substantially coincides with the longitudinal axis of the infrared temperature sensor.

12. The temperature monitor of claim 8, wherein the longitudinal axis of the infrared temperature sensor intersects a centroid of the support member.

13. The temperature monitor of claim 8, wherein the support member has a substantially flat disk shape.

14. The temperature monitor of claim 8, wherein the support member is aligned substantially perpendicular to the longitudinal axis of the infrared temperature sensor.

15. The temperature monitor of claim 8, wherein the support member is removably attached to the infrared temperature sensor.

16. An electronic food and beverage temperature monitor for detecting and monitoring a temperature of a food or beverage contained within a vessel, the temperature monitor comprising:
a housing;
a control device enclosed within the housing;
a temperature probe in communication with the control device for detecting a temperature of the food or beverage, the temperature probe operable for sending a signal to the control device indicative of the temperature of the food or beverage;
an audio device operably connected to the control device for emitting an audible tone in response to a signal received from the control device; and
a display device operably connected to the control device for displaying indicia in response to a signal received from the control device.

17. The temperature monitor of claim 16, wherein the control device is configured to cause the audio device to emit one of a plurality of audible tones when the detected temperature reaches one of a plurality of predetermined temperatures.

18. The temperature monitor of claim 17, wherein a discrete audible tone is associated with each predetermined temperature.

19. The temperature monitor of claim 16, wherein the control device is configured to cause the audio device to transmit a series of audible tones when the detected temperature falls within a predetermined range of temperatures.

20. The temperature device of claim 19, wherein the series of audible tones is emitted in a series of pulses that continue so long as the detected temperature falls within the predetermined range of temperatures.

21. The temperature device of claim 16, wherein the control device is configured to cause the audio device to emit an audible tone when the detected temperature is greater than a predetermined temperature.

22. The temperature device of claim 21, wherein the audible tone is emitted so long as the detected temperature is greater than the predetermined temperature.

23. The temperature monitor of claim 16, wherein the controller comprises means for storing a plurality of temperature ranges, each temperature range corresponding to a separate heating stage and each heating stage having a different identifier associated therewith, wherein the control device is configured to automatically compare the detected temperature with each of the predetermined temperature ranges for determining which heating stage the detected temperature falls within and to cause an identifier corresponding to the determined heating stage to be displayed on the display device.

24. The temperature monitor of claim 23, wherein the control device is configured to cause the audio device to emit a series of audible tones when the detected temperature falls within at least one of the plurality of temperature ranges.

25. The temperature monitor of claim 24, wherein the series of audible tones is emitted in a series pulses that continue so long as the detected temperature falls withing the at least one of the plurality of temperature ranges.

26. The temperature monitor of claim 23, wherein a discrete audible tone is associated with each heating stage, the controller being configured to emit the audible tone associated with the heating stage corresponding with the detected temperature.

27. The temperature monitor of claim 16, wherein the display device comprises a liquid crystal display.

28. The temperature monitor of claim 16, wherein the display device comprises at least one light emitting diode.

29. The temperature monitor of claim 16, wherein the temperature probe comprises one of a thermistor, thermocouple, resistance temperature detector, and infrared temperature sensor.

30. The temperature monitor of claim 16 further comprising a support member attached to the temperature probe and having a substantially planar portion extending radially outward from the temperature probe, the planar portion having a lower surface positioned away from the housing and which is engageable with a rim of the vessel.

31. An electronic food and beverage temperature monitor for tracking a process of heating a food or beverage contained within a vessel, the temperature monitor comprising:
a housing;
a control device enclosed within the housing;
a temperature probe in communication with the control device for detecting a temperature of the food or beverage, the temperature probe operable for sending a signal to the control device indicative of the temperature of the food or beverage;
a display device operably connected to the control device; and
means for storing a plurality of temperature ranges, each temperature range corresponding to a separate heating stage and each heating stage having a different identifier associated therewith, the storage means being in operable communication with the control device, wherein the control device is configured to automatically compare the detected temperature with each of the predetermined temperature ranges for determining which heating stage the detected temperature falls within and to cause an identifier corresponding to the determined heating stage to be displayed on the display device.

32. The temperature monitor of claim 31 further comprising an audio device for emitting an audible tone, the audio device being operably connected to the control device.

33. The temperature monitor of claim 32, wherein the control device is configured to cause the audio device to emit the audible tone when the detected temperature is at a predetermined temperature.

34. The temperature monitor of claim 32, wherein the control device is configured to cause the audio device to transmit a series of audible tones when the detected temperature falls within a predetermined range of temperatures.

35. The temperature device of claim 34, wherein the series of audible tones is emitted as a series of pulses that continue so long as the detected temperature falls within the predetermined range of temperatures.

36. The temperature device of claim 32, wherein the control device is configured to cause the audio device to emit an audible tone when the detected temperature is greater than a predetermined temperature.

37. The temperature device of claim 36, wherein the audible tone is emitted so long as the detected temperature is greater than the predetermined temperature.

38. The temperature device of claim 31, wherein the display device comprises at least one light emitting diode.

39. The temperature device of claim 31, wherein the display device comprises a liquid crystal display.

40. The temperature monitor of claim 31, wherein the temperature probe comprises one of a thermistor, thermocouple, and resistance temperature detector.

41. The temperature monitor of claim 31, wherein the temperature probe comprises an infrared temperature sensor having a viewing end for receiving infrared light emitted from the food or beverage contained in the vessel.

42. The temperature monitor of claim 31 further comprising a support member attached to the temperature probe and having a substantially planar portion extending radially outward from the temperature probe.

43. The temperature monitoring device of claim 42, wherein the substantially planar portion of the support member has an upper surface positioned toward the housing and a lower surface positioned away from the housing, the lower surface being engageable with a rim of the vessel so as to cause a longitudinal axis of the temperature probe to be aligned substantially parallel with a longitudinal axis of the vessel when the support member is placed in a resting position upon the rim of the vessel.

44. The temperature monitor of claim 42, wherein the support member is slidably mountable to the temperature probe so as to enable the support member to be positioned at a plurality of locations along a length of the temperature probe.

45. The temperature monitor of claim 42, wherein the support member has an arcuate shape forming a concave upper surface and a convex lower surface.

46. The temperature monitor of claim 45, wherein a principal axis of the support member substantially coincides with the longitudinal axis of the temperature probe.

47. The temperature monitor of claim 45, wherein the longitudinal axis of the temperature probe intersects a centroid of the support member.

48. The temperature monitor of claim 42, wherein the support member has a substantially flat disk shape.

49. The temperature monitor of claim 48, wherein the support member is aligned substantially perpendicular to the longitudinal axis of the temperature probe.

50. The temperature monitor of claim 42, wherein the support member is removably attached to the temperature probe.
